(19) United States
(12) Patent Application Publication
(10) Pub. No.: US 2018/0129915 A1
(43) Pub. Date: May 10, 2018

(54) IMAGE PROCESSING APPARATUS, IMAGE PROCESSING METHOD, AND IMAGE PROCESSING SYSTEM

(71) Applicant: CANON IMAGING SYSTEMS INC., Niigata-shi, Niigata (JP)

(72) Inventor: Yasushi INABA, Niigata-shi (JP)

(21) Appl. No.: 15/574,968

(22) PCT Filed: Jun. 7, 2016
(86) PCT No.: PCT/JP2016/067469

§ 371 Date: Nov. 17, 2017

(30) Foreign Application Priority Data
Jun. 9, 2015 (JP) 2015-116189

(51) Int. Cl. G06K 9/64; G06T 7/11; G06T 7/73; G06T 7/136; G06T 1/00

(52) U.S. Cl. CPC G06K 9/64; G06T 7/11; G06T 7/74; G06K 2209/01; G06T 1/00; G06K 2209/21; G06T 7/136

(57) ABSTRACT

An image processing apparatus includes a one-image processor and plurality-of-image processor. The one-image processor performs first image processing for recognition for identifying an object existing in the target image, and associating a recognition result with the target image, with respect to a plurality of input images without synchronization. The plurality-of-image processor determines whether the first image processings with respect to the target image and the reference images are completed. Where it is determined that it is completed and there is an object with which identification information is not associated in the target image processed by the one-image processor, it performs second image processing comparing degrees of similarity between target image and reference images, and associating identification information associated with one of the reference images with the target image based on result of comparison. Where it is determined to be not completed, it waits to execute the second image processing.

### TECHNICAL FIELD

The present invention relates to an image processing method for pictures photographed in an event, such as a marathon race.

### BACKGROUND ART

There has been known an image ordering system in which images of persons, such as visitors and event participants, are photographed by a camera in a theme park, an event site, and so forth, and are registered in a database, whereby visitors, event participants, and the like can select and buy desired person images by searching the database.

In such an image ordering system, to enhance the recognition accuracy of a race bib number of an event participant based on a person image, the present applicant has proposed an image processing apparatus that detects a person from an input image, estimates an area in which a race bib exists based on a face position of the detected person, and detects an area including a race bib number from the estimated area to thereby perform image processing on the detected area, recognize characters on the race bib number from the image subjected to image processing, and associate the result of character recognition with the input image (see PTL 1).

Further, the present applicant has proposed an image processing apparatus that compares, in a case where a race bib number is unclear, images between a plurality of input images, to thereby associate an object and the race bib number with each other (see PTL 2).

### CITATION LIST

### Patent Literature

PTL 1: Specification of Japanese Patent Application No. 2014-259258

PTL 2: Specification of Japanese Patent Application No. 2015-075185

### SUMMARY OF INVENTION

### Technical Problem

The present invention is a further evolution and development of the image processing apparatuses proposed earlier by the present applicant in PTL 1 and PTL 2, and aims to provide an image processing apparatus that processes a large amount of photographed images, an image processing method, and an image processing system, in which parallelization of image processing and synchronization are performed to improve processing speed compared with the conventional image processing apparatuses, and the recognition accuracy of a race bib number is improved.

### Solution to Problem

To solve the above-described problems, the image processing apparatus as recited in claim 1 is an image processing apparatus that repeatedly processes a plurality of input images as a target image, sequentially or in parallel, comprising a processing controller that determines a processing order of the plurality of input images, a one-image processor that performs first image processing for performing recognition processing of identification information for identifying an object existing in the target image, on a processing unit basis, and associating a result of the recognition processing with the target image, with respect to the plurality of input images without synchronization, according to the processing order determined by the processing controller, and a plurality-of-image processor that determines, on the processing unit basis, whether or not the first image processing with respect to the target image and the first image processing with respect to reference images which are sequentially positioned before or after the target image in terms of the processing order are all completed, and performs, in a case where it is determined that the first image processings are all completed, and an object which is not associated with the identification information exists in the target image processed by the one-image processor, second image processing for performing comparison of degrees of similarity between the target image and the reference images, and associating identification information associated with one of the reference images with the target image, based on a result of the comparison, whereas waits to execute the second image processing, in a case where it is determined that the first image processings are not completed.

### Advantageous Effects of Invention

According to the present invention, it is possible to perform processing for associating a race bib number with a photographed image at high speed and with high accuracy.

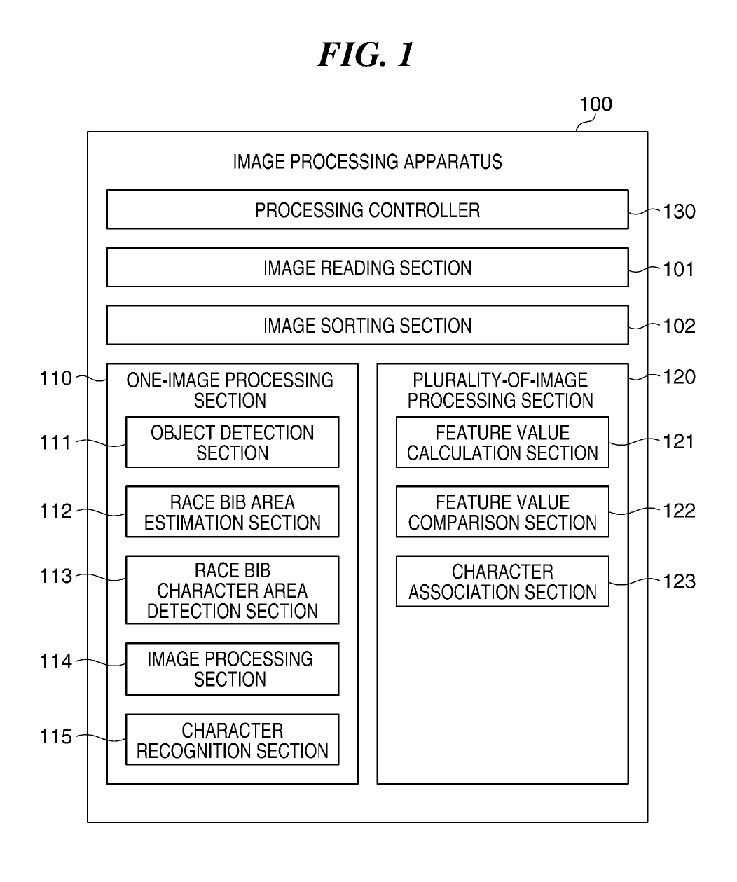

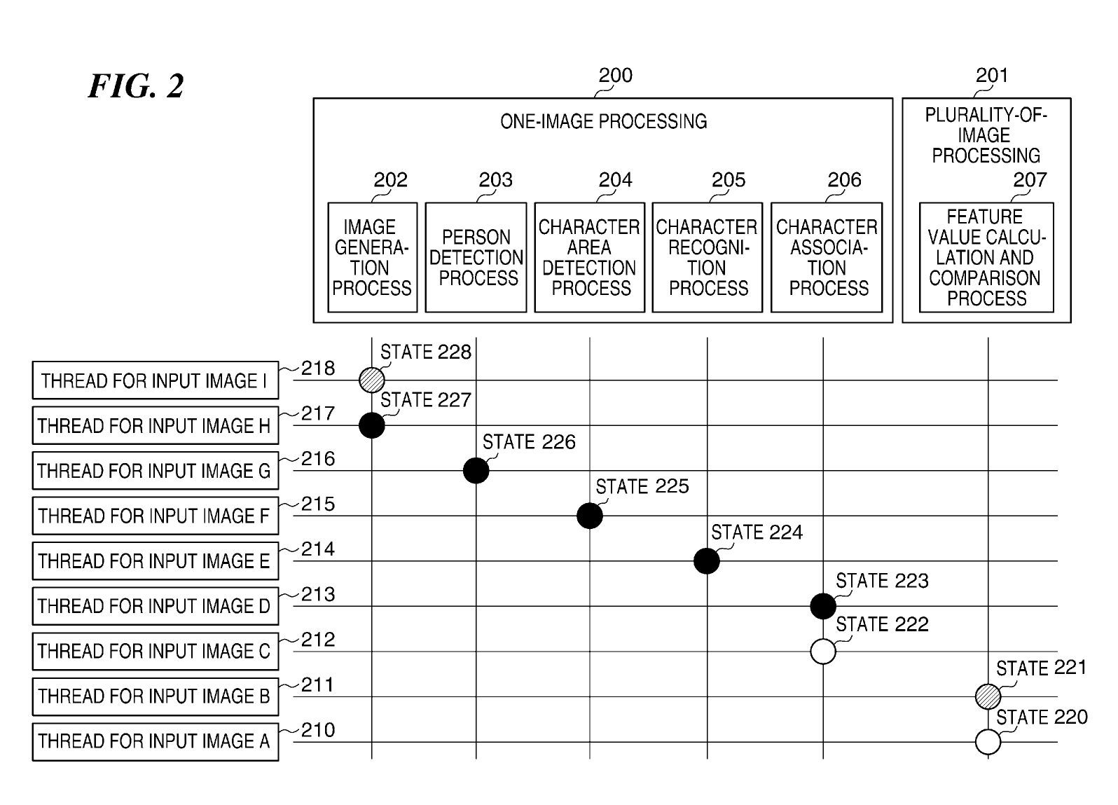

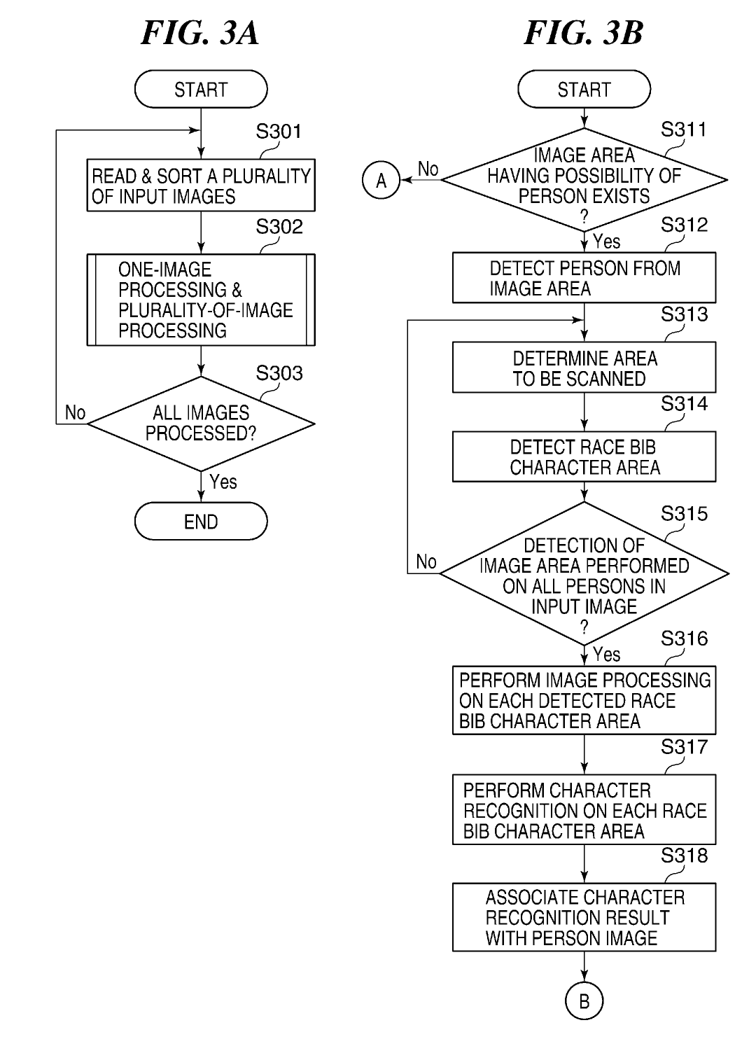

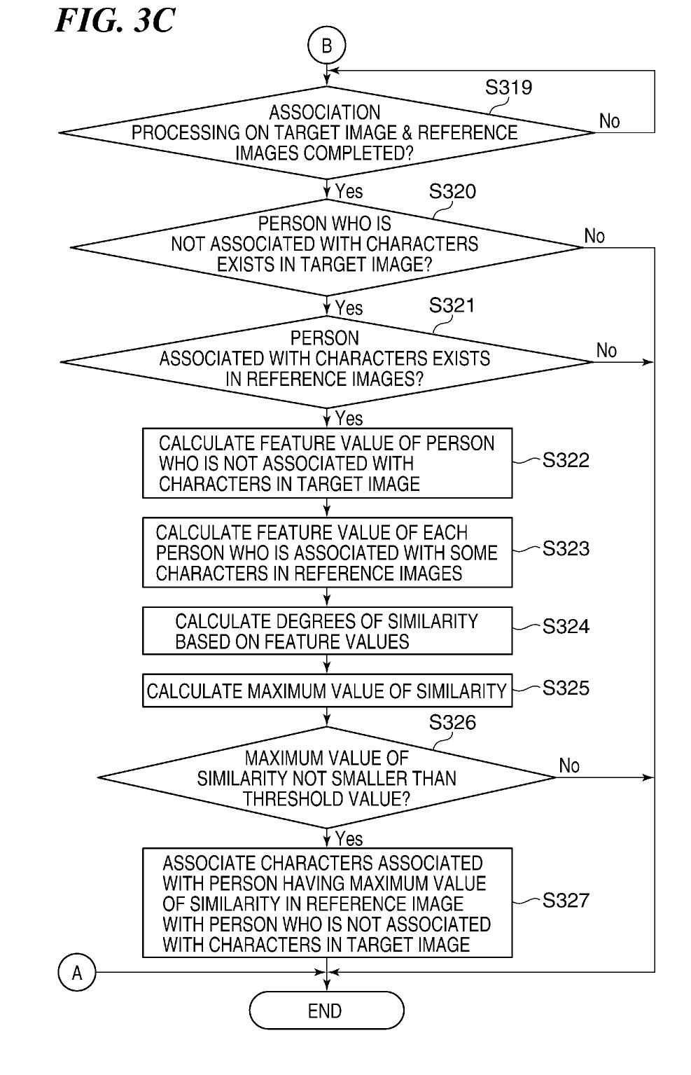

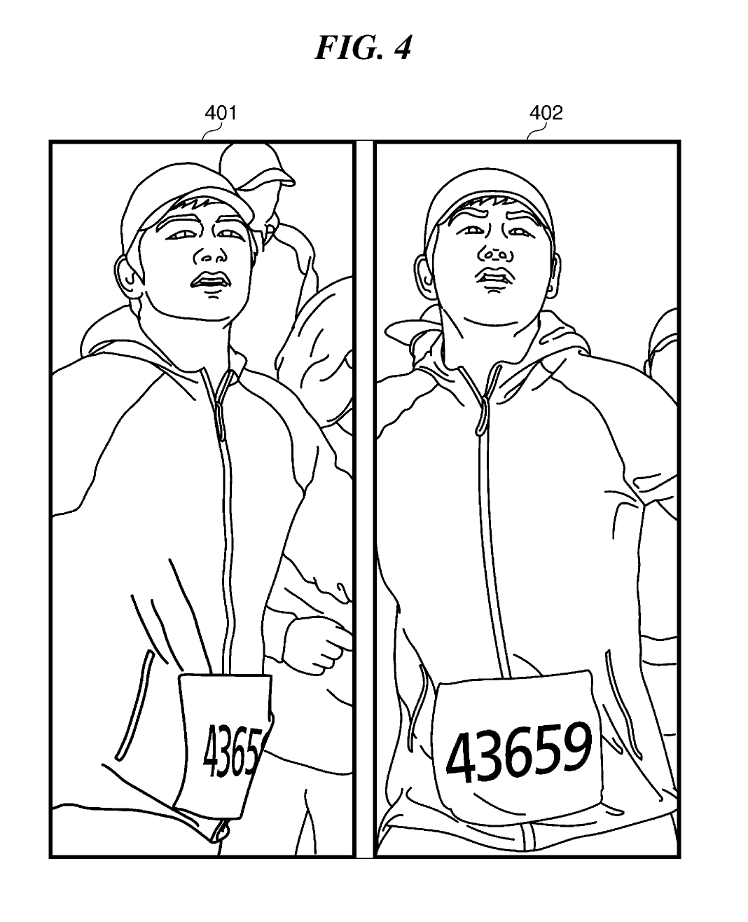

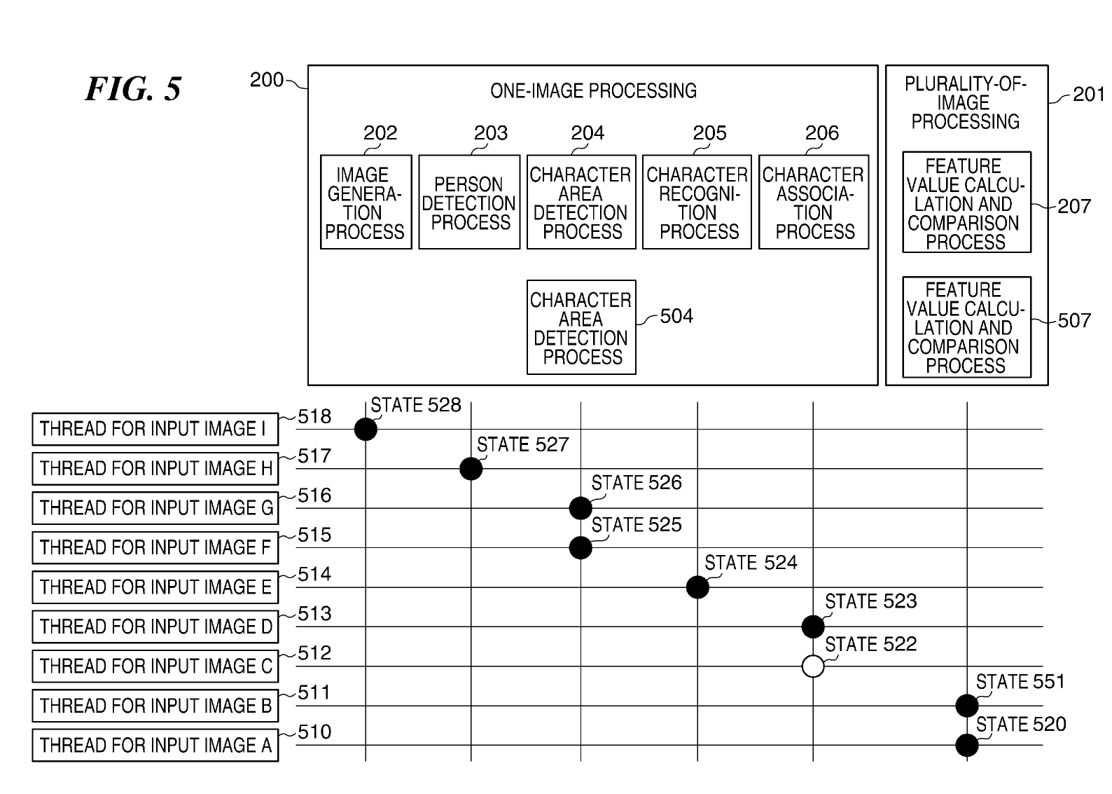

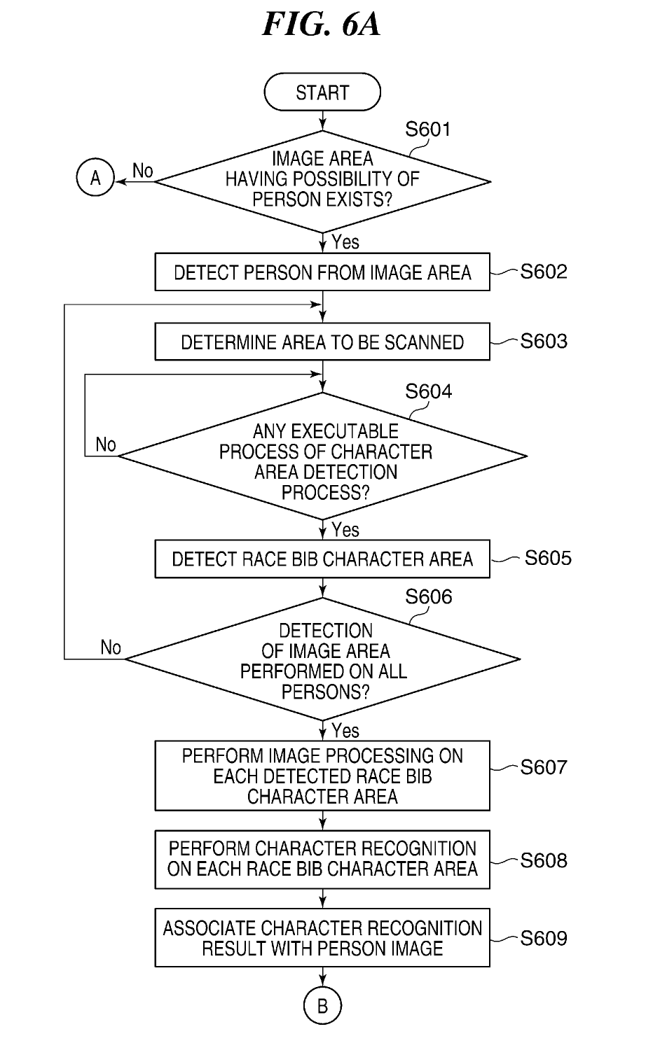

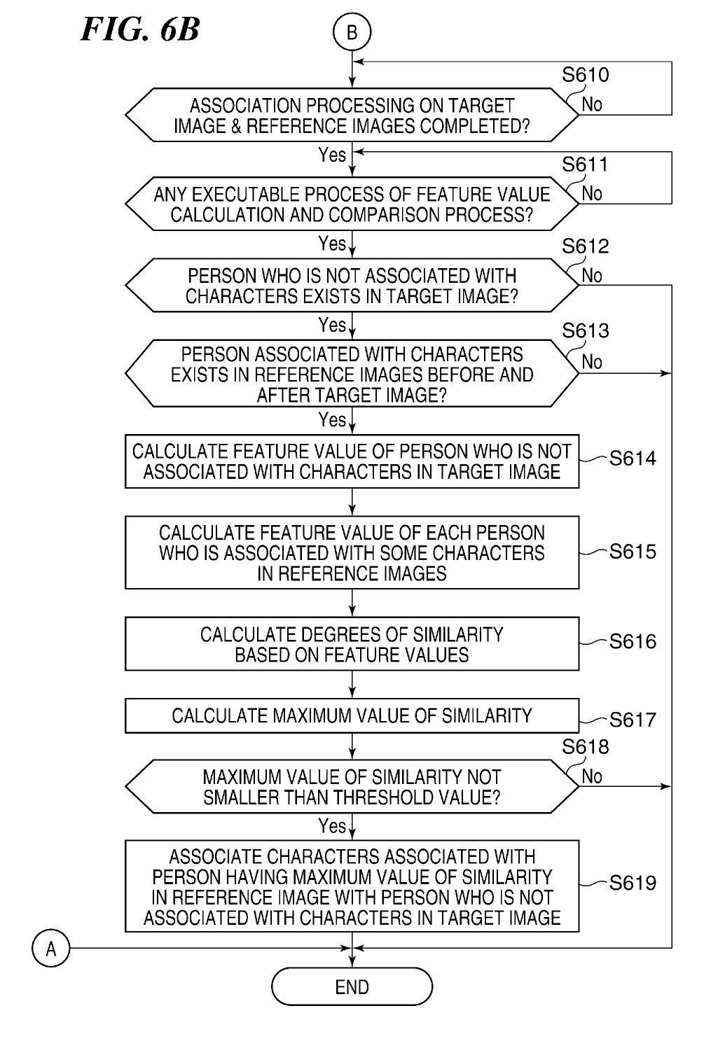

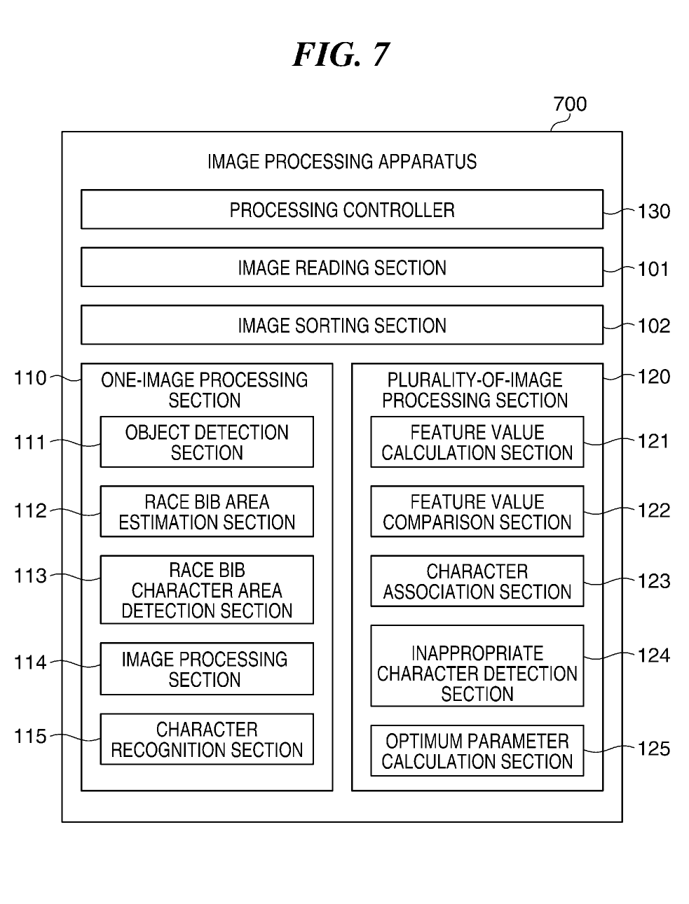

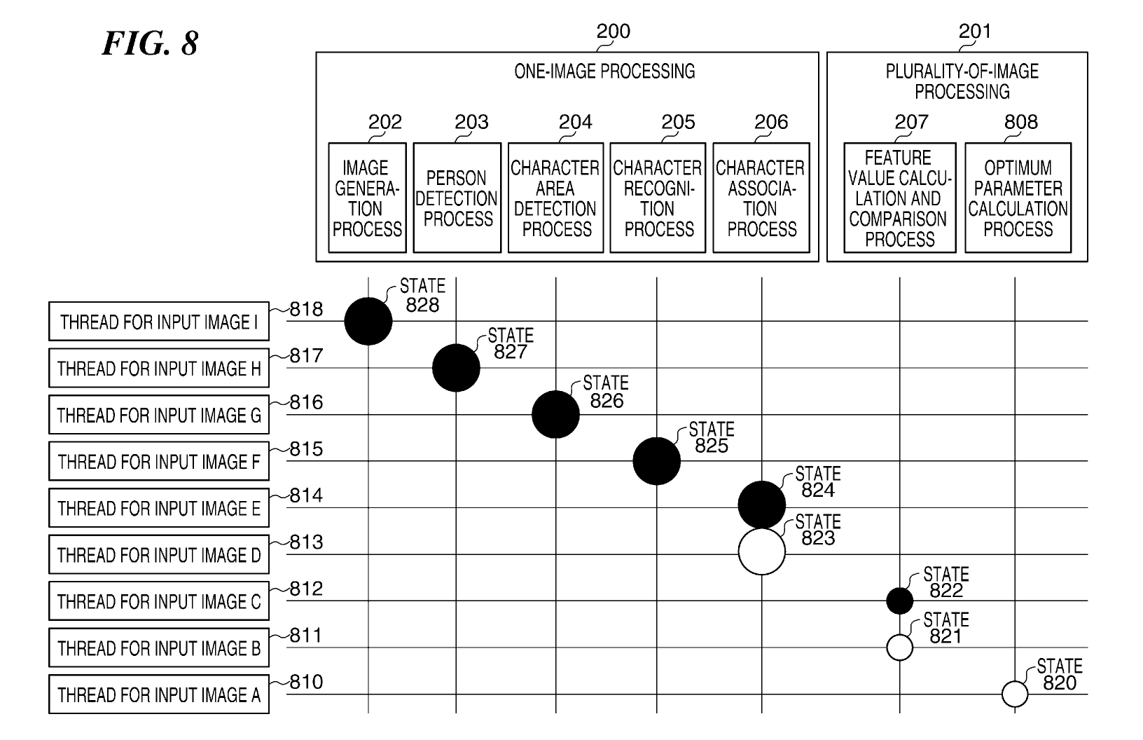

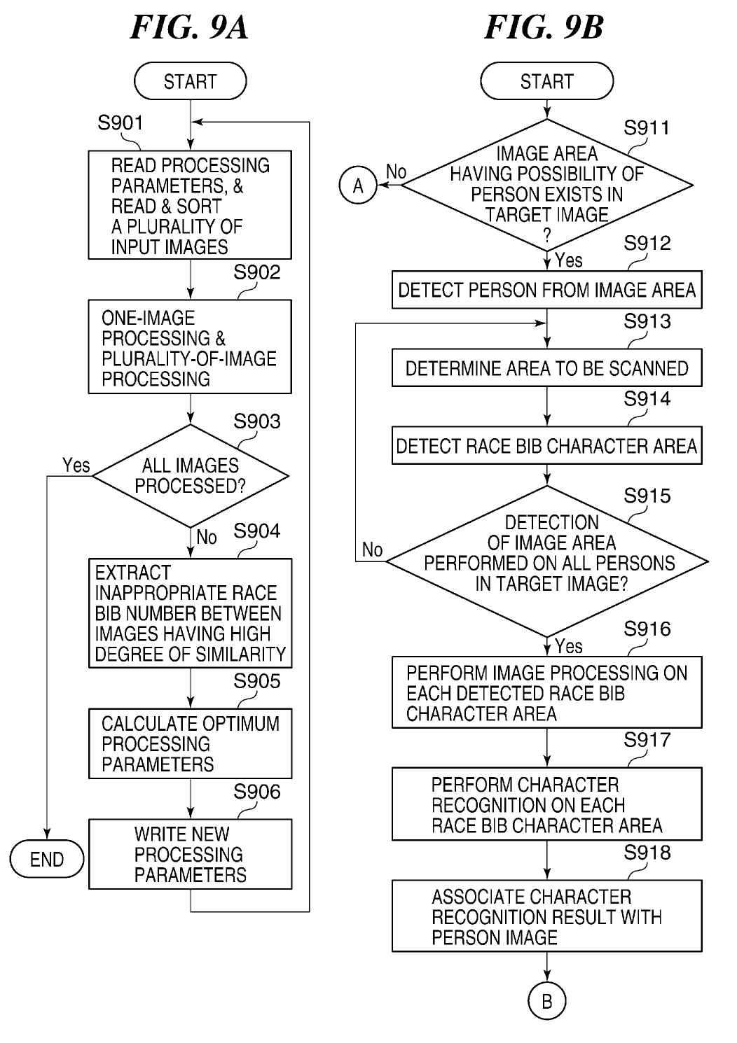

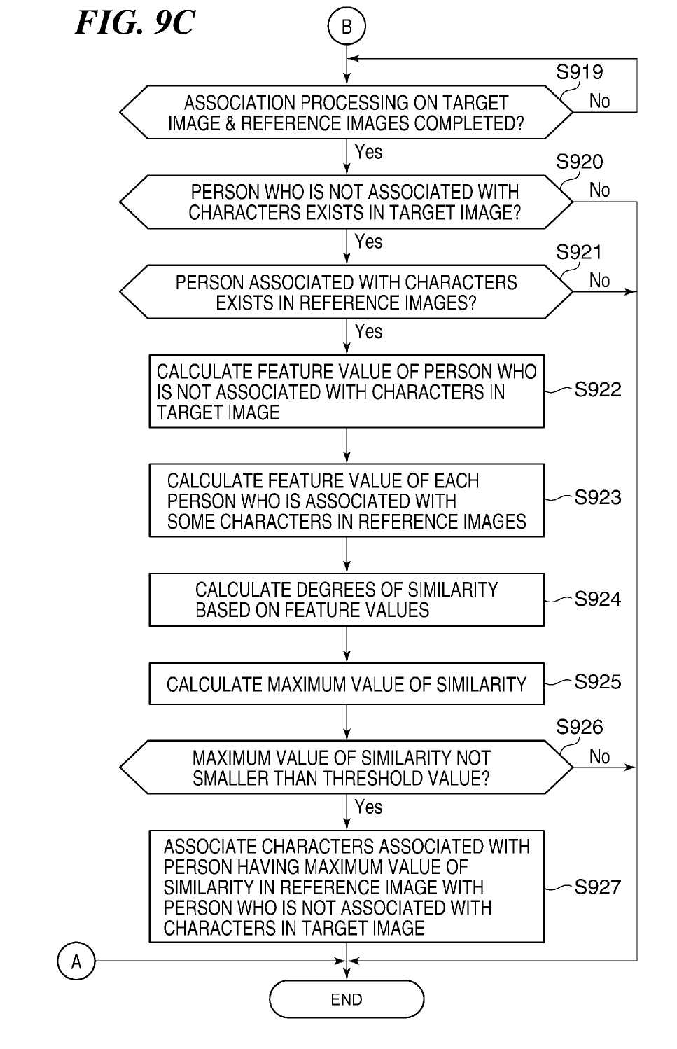

### BRIEF DESCRIPTION OF DRAWINGS

[FIG. 1] A block diagram of an example of an image processing apparatus 100 according to a first embodiment of the present invention.

[FIG. 2] A processing state diagram useful in explaining processing performed by the image processing apparatus 100, shown in FIG. 1, for associating a race bib number and a target image with each other while performing parallel processing.

[FIG. 3A] A flowchart useful in explaining entire processing of photographed images, which is performed by the image processing apparatus 100 shown in FIG. 1.

[FIG. 3B] A flowchart useful in explaining processing performed by the image processing apparatus 100 shown in FIG. 1, for associating a race bib number and a target image with each other while performing parallel processing.

[FIG. 3C] A flowchart useful in explaining the processing performed by the image processing apparatus 100 shown in FIG. 1, for associating the race bib number and the target image with each other while performing parallel processing.

[FIG. 4] A diagram useful in explaining the processing performed by the image processing apparatus 100, for associating the race bib number and the person image with each other based on the face feature values of the object.

[FIG. 5] A processing state diagram useful in explaining processing performed in a second embodiment of the present invention by the image processing apparatus 100 shown in FIG. 1, for associating a race bib number and a target image with each other while performing parallel processing.

[FIG. 6A] A flowchart useful in explaining processing performed in the second embodiment of the present invention by the image processing apparatus 100, for associating a race bib number and a target image with each other while performing parallel processing.

[FIG. 6B] A flowchart useful in explaining the processing performed in the second embodiment of the present invention by the image processing apparatus 100, for associating the race bib number and the target image with each other while performing parallel processing

[FIG. 7] A block diagram of an example of an image processing apparatus 600 according to a third embodiment of the present invention.

[FIG. 8] A processing state diagram useful in explaining processing performed by the image processing apparatus 600 shown in FIG. 7, for associating a race bib number and a target image with each other while performing parallel processing.

[FIG. 9A] A flowchart useful in explaining entire processing of photographed images, which is performed by the image processing apparatus 700 shown in FIG. 7.

[FIG. 9B] A flowchart useful in explaining processing performed by the image processing apparatus 600 shown in FIG. 7, for associating a race bib number and a target image with each other while performing parallel processing.

[FIG. 9C] A flowchart useful in explaining the processing performed by the image processing apparatus 600 shown in FIG. 7, for associating the race bib number and the target image with each other while performing parallel processing.

### DESCRIPTION OF EMBODIMENTS

The present invention will now be described in detail below with reference to the drawings showing an embodiment thereof.

### First Embodiment

### <Configuration of Image Processing Apparatus 100>

FIG. 1 is a block diagram of an example of an image processing apparatus 100 according to a first embodiment of the present invention.

The illustrated image processing apparatus 100 is an apparatus, such as a personal computer (PC). The image processing apparatus 100 may be an apparatus, such as a mobile phone, a PDA, a smartphone, and a tablet terminal.

The image processing apparatus 100 includes a CPU, a memory, a communication section, and a storage section (none of which are shown) as the hardware configuration. Note that the memory is used as a global memory when each of threads, referred to hereinafter, is processed.

The CPU controls the overall operation of the image processing apparatus 100. The memory is a RAM, a ROM, and the like.

The communication section is an interface for connecting to e.g. a LAN, a wireless communication channel, and a serial interface, and is a function section for receiving a photographed image from an image pickup apparatus.

The storage section stores, as software, an operating system (hereinafter referred to as the OS: not shown), an image reading section 101, an image sorting section 102, a one-image processing section 110, a plurality-of-image processing section 120, and a processing controller 130, and software associated with other functions. Note that these software items are read into the memory, and operate under the control of the CPU.

Hereafter, the function of each function section will be described in detail.

The image reading section 101 reads a photographed image, a display rendering image, and so on, from the memory, as an input image, and loads the read image into the memory of the image processing apparatus 100. More specifically, the image reading section 101 decompresses a compressed image file, such as a JPEG file, converts the image file to a raster image in an array of RGB values on a pixel-by-pixel, and loads the raster image into the memory of the PC. At this time, in a case where the number of pixels of the read input image is not large enough, pixel interpolation may be performed to thereby increase the number of pixels to a sufficiently large number so as to maintain a sufficient accuracy for detection of an object by an object detection section 111, and recognition by an image processing section 114 and a character recognition section 115. Further, in a case where the number of pixels is larger than necessary, the number of pixels may be reduced by thinning the pixels so as to increase the speed of processing. Further, to correct a width and height relation of an input image, the photographed image may be rotated as required.

The image sorting section 102 sorts input images loaded into the memory of the image processing apparatus 100 in a predetermined order. For example, the image sorting section 102 acquires an update time and a creation time of each input image, or an image photographing time recorded in the input image, and sorts the input images in chronological order. Here, the file format of the input image is e.g. JPEG, and if the number of input images is enormous, such as several tens of thousands, it takes a lot of time to sort the images, and hence a unit number of images to be sorted may be changed such that the input images are divided into units of several tens of images.

The one-image processing section 110 includes the object detection section 111, a race bib area estimation section 112, a race bib character area detection section 113, the image processing section 114, and the character recognition section 115, and is a function section for processing input images one by one in an order in which the input images are sorted by the image sorting section 102. For example, the one-image processing section 110 processes the input images which are arranged in a chronological ascending or descending order.

The object detection section 111 detects respective object areas existing within input images. A method of detecting an object includes, e.g. in a case of an object being a person, a method of detection based on features of a face of a person and features of organs, such as a mouth and eyes, a method of detection based on features of a shape of a head, and a method of detection based on a hue of a skin area or the like of a person, but is not limited to these, and a combination of a plurality of detection methods may be used. Hereafter, the description is given assuming that the object is a person.

The race bib area estimation section 112 estimates from a person area detected by the object detection section 111 in the input image, based on the position of a face and a shoulder width, that a race bib character area exists in a torso in a downward direction from the face. Note that the object of which the existence is to be estimated is not limited to the race bib, but may be a uniform number, or identification information directly written on part of an object. Further, the estimation is not to be performed limitedly in the downward direction, but the direction can be changed according to a posture of a person or composition of a photographed image, on an as-needed basis.

The race bib character area detection section 113 detects an area which can be characters with respect to each area estimated by the race bib area estimation section 112. Here, the characters refer to an identifier which makes it possible to uniquely identify an object, such as numbers, alphabets, hiragana, katakana, Chinese characters, numbers and symbols, and a pattern of barcode.

The image processing section 114 performs image processing with respect to each area detected by the race bib character area detection section 113 as pre-processing for character recognition.

The character recognition section 115 recognizes characters with respect to the input image processed by the image processing section 114 based on a dictionary database (not shown) in which image features of candidate characters are described, and associates the recognition result with a person image. The person image refers to part of an input image in which a person exists.

The plurality-of-image processing section 120 includes a feature value calculation section 121, a feature value comparison section 122, and a character association section 123, and is a function section for processing an input image as a target based on the result of processing by the one-image processing section 110 by referring to images temporally before and after the input image.

The feature value calculation section 121 detects each person or a person area, existing in an input image, and calculates a feature value of a face of a person and feature values of organs, such as a mouth and eyes, and a feature value based on a hue of a person area, a composition of a person with respect to the image, and so on. Here, a feature value may be calculated based on one feature, or a combination of a plurality of feature values may be used as a feature value of an input image.

The feature value comparison section 122 compares a feature value of an input image, calculated by the feature value calculation section 121, between a plurality of input images. At this time, an input image as a target is referred to as a target image, and respective n-number of input images before and after the target image, which have been sorted by the image sorting section 102 according to photographing time or the like, are referred to as the reference images. Note that the n-number of each of the preceding input images and the following input images may be changed according to a situation of an event or a photographing interval of the photographed images or the like. Further, the n-number can be changed, based on the photographing time recorded in each input image or the like (e.g. JPEG image), according to a condition that the input images are images photographed within a fixed time period. In addition, the reference images are not necessarily reference images before and after the target image, but may be only reference images before the target image or only reference images after the target image, or there may be no reference image before and after the target image.

The character association section 123 associates, in a case where a degree of similarity between a target image and a reference image is high as a result of the comparison by the feature value comparison section 122, a race bib number associated with the reference image with the target image. Here, the race bib number may be associated with an object within the target image or the photographed image itself.

The processing controller 130 determines an order of processes of the entire processing performed by sections ranging from the image reading section 101 to the character association section 123, and creates and aborts each process. In creating each process, the processing controller 130 creates one process or a plurality of processes by determining the number of processes such that each processing is not delayed. The number of processes to be created may be a fixed number defined in advance, or may be dynamically determined based on the memory capacity of a computer of the operating environment, sizes of input images, etc.

Here, the process refers to an application program whose associated executable file, setting information, etc. are read into a computer memory, for executing some coherent processing, and corresponds to an execution unit of processing.

### <State of Processing Performed by Image Processing Apparatus 100>

FIG. 2 is a processing state diagram useful in explaining processing performed by the image processing apparatus 100 shown in FIG. 1, for associating a race bib number and a target image with each other while performing parallel processing.

Referring to FIG. 2, one-image processing 200 represents processes performed by the image reading section 101, the image sorting section 102, and the one-image processing section 110, and is formed by an image generation process 202 performed by the image reading section 101 and the image sorting section 102, a person detection process 203 performed by the object detection section 111, a character area detection process 204 performed by the race bib area estimation section 112 and the race bib character area detection section 113, a character recognition process 205 performed by the image processing section 114 and the character recognition section 115, and a character association process 206 performed by the character recognition section 115. Plurality-of-image processing 201 represents a process performed by the plurality-of-image processing section 120, and is formed by a feature value calculation and comparison process 207 performed by the feature value calculation section 121, the feature value comparison section 122, and the character association section 123.

A thread 210 for an input image A to a thread 218 for an input image I (hereinafter referred to as “the thread 210 to the thread 218”) are threads formed by reading the image A to the image I sorted by the image sorting section 102 according to the photographing time or the like. Here, although the following description is given assuming that the input images are processed in a photographing time order (oldest first, latest last) from the image A to the image I, the input images are not necessarily required to be processed in the order (oldest first, latest last) but may be processed in an order (latest first, oldest last). Here, the threads refers to processing units which are created by the processing controller 130 and can be parallelized, for execution of the processes of the one-image processing section 110 and the plurality-of-image processing section 120. The processing controller 130 assigns one thread to each input image, and the thread calls each process for causing the process to process a target image.

In FIG. 2, the thread 210 to the thread 218 are processed by the image generation process 202 to the feature value calculation and comparison process 207 in parallel. FIG. 2 shows that the input images are processed by the image generation process 202 to the feature value calculation and comparison process 207 in the order sorted by the image sorting section 102, and are processed in the chronological order of the thread 210 to the thread 218. Each thread is recorded in the global memory, and can monitor the states of the other threads. Here, the global memory refers to a memory from which data can be read and into which data can be written by all of the threads.

A state 220 to a state 228 indicate that the thread 210 to the thread 218 are in respective states of processing by the image generation process 202 to the feature value calculation and comparison process 207. Here, a state 223, a state 224, a state 225, a state 226, and a state 227 each indicate a state in which the image of each thread is being processed by the corresponding process of the one-image processing 200 (denoted by a black circle). The state 220 and a state 222 each indicate a state in which the image of each thread has been processed by the corresponding process of the one-image processing 200 or the plurality-of-image processing 201 (denoted by a white circle). Further, a state 221 and the state 228 each indicate a state of the image of each thread waiting for completion of the corresponding process of the one-image processing 200 or the plurality-of-image processing 201 (denoted by a hatched circle). The thread 211 monitors the thread 212 in the feature value calculation and comparison process 207 and is in the processing waiting state, while the thread 218 monitors the thread 217 in the same image generation process 202, and waits for completion of the processing.

In each process of the image generation process 202 to the feature value calculation and comparison process 207, only one image can be processed, and hence the number of indications of the state being processed (black circle) for each process is one or none. The thread 218 is required to wait until the image generation process 202 of the thread 217 for the input image H is completed, and is in the processing waiting state (hatched circle). When the processing of the thread 217 is completed, the thread 218 is shifted to the state being processed (black circle).

The thread 212 is in a state in which the character association process 206 of the input image C is completed (white circle). Soon, the processing of the thread 212 is shifted to the next feature value calculation and comparison process 207, and the thread 212 is shifted to the processing waiting state or the state being processed.

Each thread does not interfere with the functions of the image generation process 202 to the character association process 206 of the one-image processing 200, and when the preceding process is completed, the thread is sequentially shifted to the processing state.

On the other hand, the thread 211 that executes the feature value calculation and comparison process 207 of the plurality-of-image processing 201 is required to synchronize the input image B as the target image with the input image A as the preceding reference image and the input image C as the following reference image. This is because there is a case where at least the character association process 206 of the input image A is completed, but the character association process 206 of the input image C is not completed. In this case, if the feature value calculation and comparison process 207 is performed without synchronizing these images, in a case where the character association process 206 is not completed, the target image is compared with the reference image with which characters are not properly associated, so that association of the race bib number by the character association section 123 using the target image and the reference images before and after the target image is not properly performed. For this reason, the feature value calculation and comparison process 207 of the input image B waits until the character association process 206 of the input image C is completed. By synchronizing the target image with the reference images before and after the target image in the plurality-of-image processing 201, it is possible to enhance the accuracy of association of the race bib number.

### <Processing Flow Performed by Image Processing Apparatus 100>

FIG. 3A is a flowchart useful in explaining entire processing of photographed images, which is performed by the image processing apparatus 100 shown in FIG. 1, and FIGS. 3B and 3C are flowcharts useful in explaining processing performed by the image processing apparatus 100 shown in FIG. 1, for associating a race bib number and a target image with each other while performing parallel processing.

In the following description, an input image as a target is referred to as a target image, and respective n-number of temporally sequential input images each before and after the target image, which are made sequential to the target image by sorting, are referred to as the reference images. Note that the n-number of each of the preceding input images and the following input images may be changed according to a situation of an event or a photographing interval of the photographed images or the like. Further, the n-number can be changed, based on the photographing time recorded in each input image (e.g. JPEG image), according to a condition that the input images are images photographed within a fixed time period. In addition, the reference images are not necessarily reference images before and after the target image, but may be only reference images before the target image or only reference images after the target image, or there may be no reference image before and after the target image.

Hereafter, the entire processing of photographed images will be described with reference to the flowchart in FIG. 3A.

Referring to FIG. 3A, first, the image generation process 202 is performed. More specifically, the image reading section 101 reads (2n+1) images consisting of a target image and the n-number of images each before and after the target image, as input images, whereby the processing is started, and the image sorting section 102 sorts the read (2n+1) images as the temporally sequential images based e.g. on the photographing times (step S301). Here, if the images are compressed, the image reading section 101 decompresses the compressed images. Further, the decompressed images may be rotated for correction. The sorting of the images is performed because the sorting increases the possibility that when face authentication is performed, a target person is found in the other input images which are chronologically around the target image.

The one-image processing section 110 and the plurality-of-image processing section 120 perform the processing in FIG. 3B, described hereinafter, with respect to the (2n+1) images read as the input images, in parallel as described with reference to FIG. 2 (step S302).

Then, the plurality-of-image processing section 120 determines whether or not the processing is completed with respect to all the photographed images (step S303). If the processing is completed with respect to all the photographed images (Yes to the step S303), the processing flow is terminated. If the processing is not completed with respect to all the photographed images (No to the step S303), the processing flow returns to the step S301, wherein the image reading section 101 reads (2n+1) images as the next input images.

Next, the step S302 in FIG. 3A will be described with reference to the flowchart in FIG. 3B.

A step S311 to a step S318 are executed by the one-image processing section 110, and a step S319 to a step S327 are executed by the plurality-of-image processing section 120.

Referring to FIG. 3B, first, as the person detection process 203, the object detection section 111 scans the whole raster image of the read target image, and determines whether or not there is an image area having a possibility of a person (step S311).

If there is an image area having a possibility of a person (Yes to the step S311), the processing flow proceeds to the step S312. If there is no image area having a possibility of a person (No to the step S311), the processing flow is terminated.

The object detection section 111 detects a person from the image area having a possibility of a person in the target image (step S312).

The step S313 to the step S315 correspond to the character area detection process 204.

The race bib area estimation section 112 estimates that a race bib character area is included in each person area detected by the object detection section 111, and determines an area to be scanned (step S313). The area to be scanned is determined based on a size in the vertical direction of the input image and a width of the person area, and is set to an area in the downward direction from the face of the person. Here, the size in the vertical direction and the width of the area to be scanned may be changed according to the detection method used by the object detection section 111.

The race bib character area detection section 113 detects a race bib character area from the area to be scanned, which is determined for each person (step S314). As a candidate of the race bib character area, the race bib character area detection section 113 detects an image area which can be expected to be a race bib number, such as numerals and characters, and detects an image area including one or a plurality of characters. Here, although the expression of the race bib number is used, the race bib number is not limited to numbers.

The race bib character area detection section 113 determines whether or not detection of an image area has been performed with respect to all persons in the target image (step S315), and if there is a person on which the detection has not been performed yet (No to the step S315), the processing flow returns to the step S313 so as to perform race bib character area detection with respect to all persons.

The step S316 and the step S317 correspond to the character recognition process 205.

When race bib character area detection with respect to all persons in the target image is completed (Yes to the step S315), the image processing section 114 performs image processing on each detected race bib character area as pre-processing for performing character recognition (step S316). Here, the image processing refers to deformation correction, inclination correction, depth correction, and so forth. Details of the image processing are described in the specification of Japanese Patent Application No. 2014-259258, which was filed earlier by the present applicant.

After the image processing on all of the detected race bib character areas is completed, the character recognition section 115 performs character recognition with respect to each race bib character area (step S317).

Then, as the character association process 206, the character recognition section 115 associates a result of character recognition with the person image (step S318).

When character recognition with respect to all race bib character areas is completed, the processing on one input image (here, the target image) is terminated.

Similarly, the processes for detecting a person and performing character recognition in the step S311 to the step S318 are performed also with respect to the n-number of reference images each before and after the target image, whereby it is possible to obtain results of characters associated with person images.

In the step S301, and the step S311 to the step S318, described heretofore, concerning the one-image processing 200 performed with respect to the input images, the processes for the threads associated with the respective images are performed in parallel, as shown in FIG. 2, and each thread advances processing after confirming the completion of the preceding process.

The target image goes to the feature value calculation and comparison process 207 as the plurality-of image processing 201.

The thread that executes the plurality-of-image processing section 120 determines whether or not the association processing based on the result of character recognition is completed with respect to the reference images, similarly to the target image (step S319). If the association processing is completed with respect to the target image and the reference images, the processing flow proceeds to the step S320, whereas if not, the processing flow returns to the step S319, and the thread waits until the association processing is completed with respect to the (2n+1) images of the target image and the reference images, for synchronization of the images between the plurality of threads. By performing the synchronization processing, it is possible to perform the process by the plurality-of-image processing section 120 using the reference images on which the association processing is completed based on the result of character recognition. The state 221 of the thread 211, described with reference to FIG. 2, indicates the waiting state for performing the synchronization.

The character recognition section 115 detects whether or not a person who is not associated with characters exists in the target image (step S320). If appropriate characters are associated with all of persons in the target image (No to the step S320), the processing flow is terminated.

If a person who is not associated with any characters exists in the target image (Yes to the step S320), the character recognition section 115 detects whether or not a person who is associated with any characters exists in the n-number of reference images each before and after the target image (step S321).

If a person who is associated with any characters exists in the reference images (Yes to the step S321), the feature value calculation section 121 calculates a feature value of the person who is not associated with any characters in the target image (step S322). If there is no person who is associated with any characters in the reference images, (No to the step S321), the processing flow is terminated.

Next, the feature value calculation section 121 calculates a feature value of each detected person who is associated with any characters in the reference images (step S323).

Details of the processing for feature value calculation and character association performed with respect to the target image and the reference images are described in the specification of Japanese Patent Application No. 2015-075185 which was filed earlier by the present applicant.

The feature value comparison section 122 calculates a degree of similarity between the feature value of the person who is not associated with characters in the target image and the feature value of each detected person who is associated with any characters in the reference images (step S324). The similarity is normalized using a value of 100 as a reference, and as the similarity is higher, this indicates that the feature values of the respective persons are very close to each other, and there is a high possibility that the persons are the same person.

Then, the feature value comparison section 122 calculates the maximum value of the degree of similarity out of the degrees of similarity calculated in the step S324 (step S325).

The feature value comparison section 122 determines whether or not the maximum value of the degree of similarity is not smaller than a threshold value determined in advance (step S326). If the maximum value of the degree of similarity is not smaller than the threshold value (Yes to the step S326), the character association section 123 associates the characters associated with a person having the maximum value of the feature values in the reference images with the person who is not associated with characters in the target image (step S327). If the maximum value of the degree of similarity is smaller than the threshold value (No to the step S326), the processing flow is terminated.

Here, the threshold value of the degree of similarity may be a fixed value calculated e.g. by machine learning, or may be changed for each orientation of a face. Further, the threshold value can be dynamically changed according to a resolution, a state, or the like of a target image.

FIG. 4 shows an example of input images, and the processing performed by the image processing apparatus 100, for associating a race bib number and a person image with each other based on feature values of a face, will be described with reference to FIG. 4.

An image 401 and an image 402 are images obtained by photographing the same person, and are input images temporally sequential when sorted by the image sorting section 102. The steps of the processing flow described with reference to FIG. 3B will be explained using these image 401 and the image 402.

In the image 401, although the face is oriented in a front direction, the torso is oriented in a lateral direction, and part of a race bib number is hidden, and hence all of the race bib number cannot be correctly recognized by the character recognition section 115. It is assumed that as a result of execution of the step S311 to the step S318, it is known that although image processing and number recognition are performed by the image processing section 114 and the character recognition section 115, the number cannot be correctly recognized.

Further, in the image 402, the face is similarly oriented in the front direction, and it is assumed that as a result of execution of the step S311 to the step S318, it is known that the whole race bib number can be correctly recognized by the character recognition section 115.

In the step S319, the plurality-of-image processing section 120 judges that the association processing with respect to the image 401 and the image 402 is completed, and the processing flow proceeds to the step S320.

In the step S320, although the character recognition section 115 has detected a person from the image 401, characters are not associated with the person, and hence in the step S321, the character recognition section 115 determines whether or not a person who is associated with characters is included in the image 402 sequential to the image 401.

In the step S322, the feature value calculation section 121 calculates a feature value of the face of the person in the image 401. Next, in the step S323, the feature value calculation section 121 calculates a feature value of the face of the person in the image 402.

In the step S324, the feature value comparison section 122 calculates a degree of similarity between the face feature values calculated in the step S322 and the step S323.

In the step S325, the feature value comparison section 122 calculates the maximum value of the degree of similarity. In the step S326, the feature value comparison section 122 compares the maximum value of the similarity with the threshold value, and in the step S327, since the maximum value of the degree of similarity is not smaller than the threshold value, the character association section 123 associates the characters of the image 402 with the person in the image 401.

As described above, according to the first embodiment of the present invention, in associating characters of a race bib with a target image using a feature value of a person in another input image which is temporally sequential to the target image, the one-image processing of the input images is parallelized, and further, the plurality-of-image processing waits until the one-image processing is completed to make the input images synchronized, whereby it is possible to increase the processing speed, and enhance the accuracy of recognition of a race bib number, compared with the conventional processing.

### Second Embodiment

Next, a description will be given of a second embodiment of the present invention. In the first embodiment, the processing speed is increased by parallelizing the threads for the respective input images. In the second embodiment, any of the processes of the one-image processing 200 and the plurality-of-image processing 201, which becomes a bottleneck of processing, is multiplexed, whereby the processing speed is further increased. The system configuration is substantially the same as shown in FIG. 1, and hence description thereof is omitted.

### <State of Processing in the Second Embodiment>

FIG. 5 is a processing state diagram in the second embodiment of the present invention, which is useful in explaining processing performed by the image processing apparatus 100 shown in FIG. 1, for associating a race bib number and a target image with each other while performing parallel processing.

The one-image processing 200 represents processes performed by the image reading section 101, the image sorting section 102, and the one-image processing section 110, and is formed by the image generation process 202 performed by the image reading section 101 and the image sorting section 102, the person detection process 203 performed by the object detection section 111, the character area detection process 204 and a character area detection process 504, performed by the race bib area estimation section 112 and the race bib character area detection section 113, the character recognition process 205 performed by the image processing section 114 and the character recognition section 115, and the character association process 206 performed by the character recognition section 115.

The plurality-of-image processing 201 represents processes performed by the plurality-of-image processing section 120, and is formed by the feature value calculation and comparison process 207 and a feature value calculation and comparison process 507, performed by the feature value calculation section 121, the feature value comparison section 122, and the character association section 123.

Here, the character area detection process 204 is multiplexed, whereby the character area detection process 504 which is the same process as the character area detection process 204 is created. The feature value calculation and comparison process 207 is also multiplexed, whereby the feature value calculation and comparison process 507 which is the same process as the feature value calculation and comparison process 207 is created. A program is loaded from the same executable file as that of the character area detection process 204 into a different memory, whereby the character area detection process 504 is created as a different process. Therefore, the character area detection process 204 and the character area detection process 504 perform the same processing, but can operate without interfering with each other.

The multiplexed process is a process which takes time to execute, and becomes a bottleneck in the parallel processing. Here, although the character area detection process and the feature value calculation and comparison process are each multiplexed into two processes, the multiplexed process and the number of processes into which the process is multiplexed may be changed, by taking the memory of the whole computer and the capability of the CPU into account.

A thread 510 for the input image A to a thread 518 for the input image I (hereinafter described as “the thread 510 to the thread 518”) are threads formed by reading the image A to the image I sorted by the image sorting section 102 according to the photographing time or the like. Although the following description is given assuming that the input images are processed in a photographing time order (oldest first, latest last) from the image A to the image I, the input images are not necessarily required to be processed in the order (oldest first, latest last) but may be processed in an order (latest first, oldest last).

Here, the thread 510 to the thread 518 are processed by the image generation process 202 to the feature value calculation and comparison process 507 in parallel. FIG. 5 shows that the input images are processed by the image generation process 202 to the feature value calculation and comparison process 507 in the order sorted by the image sorting section 102, and are processed in the chronological order of the thread 510 to the thread 518. Each thread is recorded in the global memory, and can monitor the states of the other threads.

A state 520 to a state 528 indicate that the thread 510 to the thread 518 are in respective states of processing by the image generation process 202 to the feature value calculation and comparison process 207. Here, the state 520, a state 521, a state 523 to a state 527, and the state 528 each indicate a state in which the image of each thread is being processed by the corresponding process of the one-image processing 200 or the plurality-of-image processing 201 (denoted by a black circle). A state 522 indicates a state in which the image of each thread has been processed by the corresponding process (denoted by a white circle).

In the image generation process 202 to the feature value calculation and comparison process 507, only one image can be processed, and hence the number of indications of the state being processed (black circle) for each process is one or none. The character area detection process 504 and the feature value calculation and comparison process 507 which are multiplexed can be executed in parallel with the character area detection process 204 and the feature value calculation and comparison process 207, respectively.

The multiplexed processes in threads can independently operate without interfering with each other, and can be executed with respect to a process which is changed into an empty state.

The thread that executes the feature value calculation and comparison process 207 and the feature value calculation and comparison process 507 of the plurality-of-image processing 201 wait until completion of the character association process 206 of the preceding and following reference images, for synchronization. If the feature value calculation and comparison process 207 is performed without synchronizing these images, in a case where the character association process 206 is not completed, the target image is compared with the reference image with which characters are not properly associated, so that association of the race bib number by the character association section 123 using the target image and the reference images before and after the target image is not properly performed. For example, in a case where the number of the preceding reference images and that of the following reference images are each equal to 1, the feature value calculation and comparison process 207 synchronizes the target image A of the thread 510 with the following image B because no preceding reference image exists, so that the target image A enters the state being processed which is indicated by the state 520 (black circle). Further, the multiplexed feature value calculation and comparison process 507 synchronizes the target image B of the thread 511 with the reference image A and the reference image B, so that the target image B enters the state being processed, which is indicated by the state 521 (black circle).

### <Processing Flow Performed in the Second Embodiment>

FIG. 6 is a flowchart useful in explaining processing performed in the second embodiment of the present invention by the image processing apparatus 100 shown in FIG. 1, for associating a race bib number and a target image with each other while performing parallel processing.

In the following description, similar to the first embodiment, an input image as a target is referred to as a target image, and respective n-number of temporally sequential input images each before and after the target image, which are made sequential to the target image by sorting, are referred to as the reference images.

The entire processing performed for photographed images is the same as the step S301 to the step S303 described with reference to FIG. 3A in the first embodiment. Details of the step S302 in the present embodiment, which is executed by the one-image processing section 110 and the plurality-of-image processing section 120 with respect to (2n+1) images read as input images, in parallel, will be described with reference to FIG. 6.

A step S601 to a step S609 are executed by the one-image processing section 110, and a step S610 to a step S619 are executed by the plurality-of-image processing section 120.

Referring to FIG. 6, first, as the person detection process 203, the object detection section 111 scans the whole raster image of the read target image, and determines whether or not there is an image area having a possibility of a person (step S601).

If there is an image area having the possibility of a person in the target image (Yes to the step S601), the processing flow proceeds to a step S602. If there is no image area having the possibility of a person in the target image (No to the step S601), the processing flow is terminated.

The object detection section 111 detects a person from the image area having the possibility of a person in the target image (step S602).

A step S603 to a step S606 correspond to the character area detection process 204 and the character area detection process 504.

The race bib area estimation section 112 estimates that a race bib character area is included in each person area detected by the object detection section 111, and determines an area to be scanned (step S603).

After the area to be scanned is determined based on the position of each person in the step S603, the processing controller 130 determines whether or not there is a process executable by the multiplexed character area detection process 504 (step S604).

If there is no executable process (No to the step S604), waiting is performed until an executable process is created upon completion of the processing of the preceding thread. If there is an executable process (Yes to the step S601), the processing flow proceeds to the step S605.

The race bib character area detection section 113 detects a race bib character area from the area to be scanned, which is determined for each person (step S605). As a candidate of the race bib character area, the race bib character area detection section 113 detects an image area which can be expected to be a race bib number, such as numerals and characters, and detects an image area including one or a plurality of characters.

The race bib character area detection section 113 determines whether or not detection of an image area has been performed with respect to all persons in the target image (step S606), and if there is a person on which the detection has not been performed yet (No to the step S606), the processing flow returns to the step S603 so as to perform race bib character area detection with respect to all persons.

A step S607 and a step S608 correspond to the character recognition process 205.

When race bib character area detection with respect to all persons is completed (Yes to the step S606), the image processing section 114 performs image processing on each detected race bib character area as pre-processing for performing character recognition (step S607).

After the image processing on all of the detected race bib character areas is completed, the character recognition section 115 performs character recognition with respect to each race bib character area (step S608).

The character association process 206 is performed. The character recognition section 115 associates a result of character recognition with the person image (step S609).

When character recognition with respect to all race bib character areas is completed, the processing on one input image (target image, here) is terminated.

Similarly, the processes for detecting a person and performing character recognition in the step S601 to the step S609 are performed also with respect to the n-number of reference images each before and after the target image, whereby it is possible to obtain the results of characters associated with person images.

In the processes, described heretofore, concerning the one-image processing 200 performed with respect to the input images, the processes for the threads associated with the respective images are performed in parallel, as shown in FIG. 2, and each thread advances processing after confirming the completion of the preceding process.

The target image goes to the feature value calculation and comparison process 207 and the feature value calculation and comparison process 507 as the plurality-of-image processing 201.

The thread that executes the plurality-of-image processing section 120 determines whether or not the association processing based on the result of character recognition is completed with respect to the reference images, similarly to the target image (step S610). If the association processing is completed with respect to all the images, the processing flow proceeds to the step S511, whereas if not, the processing flow returns to the step S510, whereby the processing flow waits until the association processing is completed with respect to the (2n+1) images of the target image and the reference images, for synchronization of the images between the plurality of threads. By performing the synchronization processing, it is possible to perform the process by the plurality-of-image processing section 120 using the reference images on which the association processing is completed based on the result of character recognition.

In the plurality-of-image processing 201 as well, the processing controller 130 determines whether or not there is a process executable by the multiplexed feature value calculation and comparison process 507 (step S611).

If there is no executable process (No to the step S611), waiting is performed until an executable process is created upon completion of the processing of the preceding thread. If there is an executable process (Yes to the step S611), the processing flow proceeds to the step S612.

The character recognition section 115 detects whether or not a person who is not associated with characters exists in the target image (step S612). If appropriate characters are associated with all of persons in the target image (No to the step S612), the processing flow is terminated.

If a person who is not associated with any characters exists in the reference images (Yes to the step S612), the character recognition section 115 detects whether or not a person who is associated with any characters exists in the n-number of reference images each before and after the target image (step S613).

If a person who is associated with some characters exists in the reference images (Yes to the step S613), the feature value calculation section 121 calculates a feature value of the person who is not associated with any characters in the target image (step S614). If there is no person who is associated with any characters in the reference images (No to the step S613), the processing flow is terminated.

Next, the feature value calculation section 121 calculates a feature value of each detected person who is associated with any characters in the reference images (step S615).

The feature value comparison section 122 calculates a degree of similarity between the feature value of the person who is not associated with characters in the target image and the feature value of each detected person who is associated with any characters in the reference images (step S616).

Then, the feature value comparison section 122 calculates the maximum value of the degree of similarity out of the degrees of similarity calculated in the step S516 (step S617).

The feature value comparison section 122 determines whether or not the maximum value of the degree of similarity is not smaller than a threshold value determined in advance (step S618). If the maximum value of the degree of similarity is not smaller than the threshold value (Yes to the step S618), the character association section 123 associates the characters associated with a person having the maximum value of the feature values in the reference images with the person who is not associated with characters in the target image (step S619). If the maximum value of the degree of similarity is smaller than the threshold value (No to the step S618), the processing flow is terminated.

As described above, according to the second embodiment of the present invention, by multiplexing process which can be a bottleneck, it is possible to reduce the number of times of a thread entering the waiting state.

### Third Embodiment

### <Configuration of Image Processing Apparatus 700>

FIG. 7 is a block diagram of an example of an image processing apparatus 700 according to a third embodiment of the present invention. In the third embodiment, optimum processing parameters are calculated by the plurality-of-image processing 201, and the calculated parameters are reflected on subsequent processes, whereby the processing speed is further increased.

The image reading section 101 to the character association section 123 and the processing controller 130 are configured similar to those of the image processing apparatus 100, and hence description thereof is omitted. The plurality-of-image processing section 120 of the image processing apparatus 700 includes, in addition to the configuration of the image processing apparatus 100, an inappropriate character detection section 124 and an optimum parameter calculation section 125.

If part of a race bib is hidden by a hand or the like, it is impossible to correctly read the race bib number. When a degree of similarity is calculated between a plurality of input images, if the images or the objects have a high degree of similarity, but the detected race bib numbers are not similar to each other, the inappropriate character detection section 124 judges that this is a case where part of the number is hidden, and detects the race bib number as an inappropriate race bib number.

The optimum parameter calculation section 125 calculates various optimum processing parameters based on a result of the detection by the inappropriate character detection section 124. For example, an area hidden by a hand or the like is estimated, and correction e.g. for enlarging the area to be detected is performed by the race bib area detection section 113.

### <State of Processing Performed by Image Processing Apparatus 700>

FIG. 8 is a processing state diagram in the third embodiment, which is useful in explaining processing performed by the image processing apparatus 700 shown in FIG. 7, for associating a race bib number and a target image with each other while performing parallel processing.

The one-image processing 200 represents processes performed by the image reading section 101, the image sorting section 102, and the one-image processing section 110, and is formed by the image generation process 202 performed by the image reading section 101 and the image sorting section 102, the person detection process 203 performed by the object detection section 111, the character area detection process 204 performed by the race bib area estimation section 112 and the race bib character area detection section 113, the character recognition process 205 performed by the image processing section 114 and the character recognition section 115, and the character association process 206 performed by the character recognition section 115.

The plurality-of-image processing 201 represents processes performed by the plurality-of-image processing section 120, and is formed by the feature value calculation and comparison process 207 performed by the feature value calculation section 121, the feature value comparison section 122, and the character association section 123, and an optimum parameter calculation process 808 performed by the inappropriate character detection section 124 and the optimum parameter calculation section 125.

A thread 810 for the input image A to a thread 818 for the input image I (hereinafter described as “the thread 810 to the thread 818”) are threads formed by reading the image A to the image I sorted by the image sorting section 102 according to the photographing time or the like. Although the following description is given assuming that the input images are processed in a photographing time order (oldest first, latest last) from the image A to the image I, the input images are not necessarily required to be processed in the order (oldest first, latest last) but may be processed in an order (latest first, oldest last). Each thread is recorded in the global memory, and can monitor the states of the other threads.

A state 820 to a state 828 indicate that the thread 810 to the thread 818 are in respective states of processing by the image generation process 202 to the feature value calculation and comparison process 207 and the optimum parameter calculation process 808. Here, a state 822 and a state 824 to a state 828 each indicate a state in which the image of each thread is being processed by the corresponding process of the one-image processing 200 or the plurality-of-image processing 201 (denoted by a black circle). A state 820 to a state 821 and a state 823 each indicate a state in which the image of each thread has been processed by the corresponding process of the one-image processing 200 or the plurality-of-image processing 201 (denoted by a white circle).

Here, the state 824 to the state 828 each indicate the state in which the corresponding processing is being executed using the optimum processing parameters generated based on the result of the optimum parameter calculation process 808 of the thread 810, by the enlarged size of the black circle or the white circle. Further, the state 823 indicates that the processing is completed using the optimum processing parameters.

### <Processing Flow Performed by Image Processing Apparatus 700>

FIG. 9A is a flowchart useful in explaining entire processing of photographed images, which is performed by the image processing apparatus 700 shown in FIG. 7, and FIG. 9B and FIG. 9C are flowcharts useful in explaining the processing performed by the image processing apparatus 600 shown in FIG. 7, for associating a race bib number and a target image with each other while performing parallel processing.

[FIG. 9C] A flowchart useful in explaining the processing performed by the image processing apparatus 600 shown in FIG. 7, for associating a race bib number and a target image with each other while performing parallel processing.

In the following description, similar to the first embodiment, an input image as a target is referred to as a target image, and respective n-number of temporally sequential input images each before and after the target image, which are made sequential to the target image by sorting, are referred to as the reference images.

Hereafter, the entire processing of photographed images will be described with reference to the flowchart in FIG. 9A.

Referring to FIG. 9A, as the image generation process 202, more specifically, the image reading section 101 reads the processing parameters, and reads (2n+1) images including a target image and respective n-number of images each before and after the target image, as input images, whereby the processing is started, and the image sorting section 102 sorts the read (2n+1) images as the temporally sequential images based on the photographing time or the like (step S901). Here, if the images are compressed, the image reading section 101 decompresses the compressed images. Further, the decompressed images may be rotated for correction.

The one-image processing section 110 and the plurality-of-image processing section 120 perform the processing in FIG. 8B, described hereinafter, with respect to the (2n+1) images read as the input images, in parallel as described with reference to FIG. 7 (step S902).

The plurality-of-image processing section 120 determines whether or not the processing is completed with respect to all the photographed images (step S903). If the processing is completed with respect to all the photographed images (Yes to the step S903), the processing flow is terminated. If the processing is not completed with respect to all the photographed images (No to the step S903), the processing flow proceeds to a step S904.

The inappropriate character detection section 124 detects an inappropriate race bib number between images which have a high degree of similarity of the feature value but lack the same race bib number (step S904). Here, the inappropriate race bib number refers e.g. to a race bib number from which the number is not correctly recognized e.g. due to a shadow.

The optimum parameter calculation section 125 calculates optimum processing parameters based on the result of detection by the inappropriate character detection section 124 (step S905).

The new processing parameters calculated in the step S805 are written e.g. into the global memory or a file in the computer (step S906). The processing flow returns to the step S901, and the next thread is subjected to the processes based on the new processing parameters.

Next, the step S902 will be described with reference to the flowchart in FIG. 9B.

A step S911 to a step S918 are executed by the one-image processing section 110, and a step S919 to a step S927 are executed by the plurality-of-image processing section 120.

First, the person detection process 203 is performed. The object detection section 111 scans the whole raster image of the read target image, and determines whether or not there is an image area having a possibility of a person (step S911).

If there is an image area having a possibility of a person (Yes to the step S911), the processing flow proceeds to a step S912. If there is no image area having a possibility of a person (No to the step S911), the processing flow is terminated.

The object detection section 111 detects a person from the image area having the possibility of a person in the target image (step S912).

A step S913 to a step S915 correspond to the character area detection process 204.

The race bib area estimation section 112 estimates that a race bib character area is included in each person area detected by the object detection section 111, and determines an area to be scanned (step S913). The area to be scanned is determined based on a size in the vertical direction of the input image and a width of the person area, and is set to an area in the downward direction from the face of the person. Here, the size in the vertical direction and the width of the area to be scanned may be changed according to the detection method used by the object detection section 111.

The race bib character area detection section 113 detects a race bib character area from the area to be scanned, which is determined for each person (step S914). As a candidate of the race bib character area, the race bib character area detection section 113 detects an image area which can be expected to be a race bib number, such as numerals and characters, and detects an image area including one or a plurality of characters. Here, although the expression of the race bib number is used, the race bib number is not limited to numbers.

The race bib character area detection section 113 determines whether or not detection of an image area has been performed with respect to all persons in the target image (step S915), and if there is a person on which the detection has not been performed yet (No to the step S915), the processing flow returns to the step S813 so as to perform race bib character area detection with respect to all persons.

A step S916 and a strep S917 correspond to the character recognition process 205.

When race bib character area detection with respect to all persons in the target image is completed (Yes to the step S915), the image processing section 114 performs image processing on each detected race bib character area as pre-processing for performing character recognition (step S916).

After the image processing on all the detected race bib character areas is completed, the character recognition section 115 performs character recognition with respect to each race bib character area (step S917).

The character association process 206 is performed. The character recognition section 115 associates a result of character recognition with the person image (step S918).

When character recognition with respect to all race bib character areas is completed, the processing on one input image (here, the target image) is terminated.

Similarly, the processes for detecting a person and performing character recognition in the step S911 to the step S918 are performed also with respect to the n-number of reference images each before and after the target image, whereby it is possible to obtain the results of characters associated with person images.

In the step S901, and the step S911 to the step S918, described heretofore, concerning the one-image processing 200 performed with respect to the input images, the processes for the threads associated with the respective images are performed in parallel, and each thread advances processing after confirming the completion of the preceding process.

The target image goes to the feature value calculation and comparison process 207 included in the plurality-of-image processing 201.

The thread that executes the plurality-of-image processing section 120 determines whether or not the association processing based on the result of character recognition is completed with respect to the reference images, similarly to the target image (step S919). If the association processing is all completed with respect to the target image and the reference images, the processing flow proceeds to the step S920, whereas if not, the processing flow returns to the step S819, whereby the thread waits until the association processing is completed with respect to the (2n+1) images of the target image and the reference images, for synchronization of the images between the plurality of threads. By performing the synchronization processing, it is possible to perform the processing by the plurality-of-image processing section 120 using the reference images on which the association processing is completed based on the result of character recognition.

The character recognition section 115 detects whether or not a person who is not associated with characters exists in the target image (step S920). If appropriate characters are associated with all persons in the target image (No to the step S920), the processing flow is terminated.

If a person who is not associated with any characters exists in the target image (Yes to the step S920), the character recognition section 115 detects whether or not a person who is associated with any characters exists in the n-number of reference images each before and after the target image (step S921).

If a person who is associated with any characters exists in the reference images (Yes to the step S921), the feature value calculation section 121 calculates a feature value of the person who is not associated with any characters in the target image (step S922). If there is no person who is associated with any characters in the reference images (No to the step S921), the processing flow is terminated.

Next, the feature value calculation section 121 calculates a feature value of each detected person who is associated with any characters in the reference images (step S923).

The feature value comparison section 122 calculates a degree of similarity between the feature value of the person who is not associated with characters in the target image and the feature value of each detected person who is associated with any characters in the reference images (step S924). The similarity is normalized using a value of 100 as a reference, and as the similarity is higher, this indicates that the respective feature values are very close to each other, and there is a high possibility that the persons are the same person.

Then, the feature value comparison section 122 calculates the maximum value of the degree of similarity out of the degrees of similarity calculated in the step S924 (step S925).

The feature value comparison section 122 determines whether or not the maximum value of the degree of similarity is not smaller than a threshold value determined in advance (step S926). If the maximum value of the degree of similarity is not smaller than the threshold value (Yes to the step S926), the character association section 123 associates the characters associated with a person having the maximum value of the feature values in the reference images with the person who is not associated with characters in the target image (step S927). If the maximum value of the degree of similarity is smaller than the threshold value (No to the step S926), the processing flow is terminated.

Here, the threshold value of the degree of similarity may be a fixed value calculated e.g. by machine learning, or may be changed for each orientation of a face. Further, the threshold value can be dynamically changed according to a resolution, a state, or the like of a target image.

As described above, according to the third embodiment of the present invention, the optimum parameters are generated based on the result of the preceding processing in the parallel processing, and then the generated parameters are reflected on subsequent processes, whereby it is possible to calculate a result with high accuracy.

Although the present invention has been described heretofore based on the embodiments, it should be noted that the present invention is not limited to the above-described embodiments, but it can be practiced in various forms, without departing from the spirit and scope thereof.

When putting the present invention into practice, any of the first embodiment to the third embodiment may be used, or any combination of the plurality of embodiments may be used.

As described above, according to the first embodiment to the third embodiment, in the system for associating characters on a race bib with a picture of an event participant, by parallel processing, the one-image processing is performed without performing synchronization, and the plurality-of-image processing waits for completion of the one-image processing to perform synchronization, whereby it is possible to increase the processing speed and improve the accuracy of recognition of a race bib number, compared with the conventional processing.

Although in the above-described example, each thread monitors the state of the threads before and after the self thread, and waits for completion of the one-image processing or performs synchronization, this is not limitative. For example, the processing controller 130 may monitor and manage the whole threads, whereby it is possible to make a plurality of threads images asynchronous or synchronous therebetween.

Further, it is to be understood that the present invention may also be accomplished by supplying a system or an apparatus with a storage medium in which is stored a program code of software, which realizes the functions of the above described embodiments, and causing a computer (or a CPU, an MPU or the like) of the system or apparatus to read out and execute the program code stored in the storage medium.

In this case, the program code itself read out from the storage medium realizes the functions of the above-described embodiments, and the computer-readable storage medium storing the program code forms the present invention.

Further, an OS (operating system) or the like operating on a computer performs part or all of actual processes based on commands from the program code, and the functions of the above-described embodiments may be realized by these processes.

Further, after the program code read out from the storage medium is written into a memory provided in a function expansion board inserted in the computer or a function expansion unit connected to the computer, a CPU or the like provided in the function expansion board or the function expansion unit executes part or all of the actual processes based on commands from the program code, and the above-described embodiments may be realized according to the processes.

To supply the program code, a recording medium, such as a floppy (registered trademark) disk, a hard disk, a magneto-optical disk, an optical disk typified by a CD or a DVD, a magnetic tape, a nonvolatile memory card, and a ROM, can be used. Further, the program code may be downloaded via a network.

### REFERENCE SIGNS LIST

101 image reading section
102 image sorting section
110 one-image processing section
111 object detection section
112 race bib area estimation section
113 race bib character area detection section
114 image processing section
115 character recognition section
120 plurality-of-image processing section
121 feature value calculation section
122 feature value comparison section
123 character association section
124 inappropriate character detection section
125 optimum parameter calculation section
130 processing controller

1. An image processing apparatus that repeatedly processes a plurality of input images as a target image, sequentially or in parallel, comprising:
a processing controller that determines a processing order of the plurality of input images;
a one-image processor that performs first image processing for performing recognition processing of identification information for identifying an object existing in the target image, on a processing unit basis, and associating a result of the recognition processing with the target image, with respect to the plurality of input images without synchronization, according to the processing order determined by the processing controller; and
a plurality-of-image processor that determines, on the processing unit basis, whether or not the first image processing with respect to the target image and the first image processing with respect to reference images which are sequentially positioned before or after the target image in terms of the processing order are all completed, and
performs, in a case where it is determined that the first image processings are all completed, and an object which is not associated with the identification information exists in the target image processed by the one-image processor, second image processing for performing comparison of degrees of similarity between the target image and the reference images, and associating identification information associated with one of the reference images with the target image, based on a result of the comparison, whereas
waits to execute the second image processing, in a case where it is determined that the first image processings are not completed.

2. The image processing apparatus according to claim 1, wherein the processing controller creates at least one execution unit of the first image processing and/or execution unit of the second image processing, according to the number of processes set in advance or the number of processes dynamically determined.

3. The image processing apparatus according to claim 2, wherein in a case where the number of execution units of the first image processing is less than the number of processing units of the input images, and it is determined that the first image processing is not completed with respect to the target image by the corresponding execution unit, the one-image processor waits to execute the first image processing with respect to the reference image which is sequentially positioned after the target image in terms of the processing order.

4. The image processing apparatus according to claim 2, wherein in a case where the number of execution units of the second image processing is less than the number of processing units of the input images, the plurality-of-image processor waits to execute the first image processing or to execute the second image processing, with respect to the reference image which is sequentially positioned after the target image in terms of the processing order.

5. The image processing apparatus according to claim 3, wherein in a case where the number of execution units of the second image processing is less than the number of processing units of the input images, the plurality-of-image processor waits to execute the first image processing or to execute the second image processing, with respect to the reference image which is sequentially positioned after the target image in terms of the processing order.

6. The image processing apparatus according to claim 2, wherein the plurality-of-image processor further includes an optimum parameter calculation section that calculates parameters optimized based on a result of the second image processing, and causes the parameters to be reflected on the execution units created by the processing controller.

7. The image processing apparatus according to claim 3, wherein the plurality-of-image processor further includes an optimum parameter calculation section that calculates parameters optimized based on a result of the second image processing, and causes the parameters to be reflected on the execution units created by the processing controller.

8. The image processing apparatus according to claim 4, wherein the plurality-of-image processor further includes an optimum parameter calculation section that calculates parameters optimized based on a result of the second image processing, and causes the parameters to be reflected on the execution units created by the processing controller.

9. The image processing apparatus according to claim 5, wherein the plurality-of-image processor further includes an optimum parameter calculation section that calculates parameters optimized based on a result of the second image processing, and causes the parameters to be reflected on the execution units created by the processing controller.

10. An image processing method for an image processing apparatus that repeatedly processes a plurality of input images as a target image, sequentially or in parallel, comprising:
a processing control step of determining a processing order of the plurality of input images;
a one-image processing step of performing first image processing for performing recognition processing of identification information for identifying an object existing in the target image, on a processing unit basis, and associating a result of the recognition processing with the target image, with respect to the plurality of input images without synchronization, according to the processing order determined by the processing control step; and
a plurality-of-image processing step of determining, on the processing unit basis, whether or not the first image processing with respect to the target image and the first image processing with respect to reference images which are sequentially positioned before or after the target image in terms of the processing order are all completed, and
performing, in a case where it is determined that the first image processings are all completed, and an object which is not associated with the identification information exists in the target image processed by the one-image processing step, second image processing for performing comparison of degrees of similarity between the target image and the reference images, and associating identification information associated with one of the reference images with the target image, based on a result of the comparison, whereas
waiting to execute the second image processing, in a case where it is determined that the first image processings are not completed.

11. The image processing method according to claim 10, wherein the processing control step creates at least one execution unit of the first image processing and/or execution unit of the second image processing, according to the number of processes set in advance or the number of processes dynamically determined.

12. The image processing method according to claim 11, wherein in a case where the number of execution units of the first image processing is less than the number of processing units of the input images, and it is determined that the first image processing is not completed with respect to the target image by the corresponding execution unit, the one-image processing step waits to execute the first image processing with respect to the reference image which is sequentially positioned after the target image in terms of the processing order.

13. The image processing method according to claim 11, wherein in a case where the number of execution units of the second image processing is less than the number of processing units of the input images, the plurality-of-image processing step waits to execute the first image processing or to execute the second image processing, with respect to the reference image which is sequentially positioned after the target image in terms of the processing order.

14. The image processing method according to claim 12, wherein in a case where the number of execution units of the second image processing is less than the number of processing units of the input images, the plurality-of-image processing step waits to execute the first image processing or to execute the second image processing, with respect to the reference image which is sequentially positioned after the target image in terms of the processing order.

15. The image processing method according to claim 11, wherein the plurality-of-image processing step further includes an optimum parameter calculation step of calculating parameters optimized based on a result of the second image processing, and causing the parameters to be reflected on the execution units created by the processing control step.

16. The image processing method according to claim 12, wherein the plurality-of-image processing step further includes an optimum parameter calculation step of calculating parameters optimized based on a result of the second image processing, and causing the parameters to be reflected on the execution units created by the processing control step.

17. The image processing method according to claim 13, wherein the plurality-of-image processing step further includes an optimum parameter calculation step of calculating parameters optimized based on a result of the second image processing, and causing the parameters to be reflected on the execution units created by the processing control step.

18. The image processing method according to claim 14, wherein the plurality-of-image processing step further includes an optimum parameter calculation step of calculating parameters optimized based on a result of the second image processing, and causing the parameters to be reflected on the execution units created by the processing control step.

19. An image processing system including an image pickup apparatus that photographs an object, and an image processing apparatus that is connected to the image pickup apparatus by wired connection or wireless connection,
wherein the image processing apparatus that repeatedly processes a plurality of input images as a target image sequentially or in parallel, and comprises:
a processing controller that determines a processing order of the plurality of input images;
a one-image processor that performs first image processing for performing recognition processing of identification information for identifying an object existing in the target image, on a processing unit basis, and associating a result of the recognition processing with the target image, with respect to the plurality of input images without synchronization, according to the processing order determined by the processing controller; and
a plurality-of-image processor that determines, on the processing unit basis, whether or not the first image processing with respect to the target image and the first image processing with respect to reference images which are sequentially positioned before or after the target image in terms of the processing order are all completed, and
performs, in a case where it is determined that the first image processings are all completed, and an object which is not associated with the identification information exists in the target image processed by the one-image processor, second image processing for performing comparison of degrees of similarity between the target image and the reference images, and associating identification information associated with one of the reference images with the target image, based on a result of the comparison, whereas
waits to execute the second image processing, in a case where it is determined that the first image processings are not completed.
